(19) United States
(12) Patent Application Publication
(10) Pub. No.: US 2022/0242181 A1
(43) Pub. Date: Aug. 4, 2022

(54) Triphibian Vehicle

(71) Applicant: YANJUN CHE, NIAGARA FALLS (CA)

(72) Inventor: YANJUN CHE, NIAGARA FALLS (CA)

(21) Appl. No.: 17/531,621

(22) Filed: Nov. 19, 2021

Related U.S. Application Data
(63) Continuation-in-part of application No. 15/802,861, filed on Nov. 3, 2017, now Pat. No. 11,179,989.

(51) Int. Cl. B60F 5/02; B64C 37/00; B64C 11/46; B60K 1/04

(52) U.S. Cl. CPC B60F 5/02; B60K 1/04; B64C 11/46; B64C 37/00

(57) ABSTRACT

The invention discloses a vertical take-off and landing triphibian flight vehicle that can travel on land, water and air. These three traveling modes are realized by changing the position of the propeller module. The vehicle has retractable and foldable wings and has the accommodate space in the vehicle body to store the wings. When the vehicle is in land mode, the wings are stowed in the accommodate space to reduce the size of the vehicle and the air resistance. When the vehicle is in flight mode, the wings can be extended out of the accommodate space through the control system, so that the vehicle can use the wings to obtain aerodynamic force to counter gravity, thereby reducing the energy consumption required for countering gravity during flight and increasing the flight mileage.

### CROSS-REFERENCE TO RELATED APPLICATIONS

This application is a Continuation-In-Part application of U.S. Ser. No. 15/802,861 filed Nov. 3, 2017. The subject matter of each of the above-referenced applications is incorporated in entirety by reference.

### BACKGROUND OF THE INVENTION

### A. Field of the Invention

The invention is a triphibian vehicle that may travel in land, water and air. The triphibian vehicle mainly includes at least one airscrew module and self-power battery device. The triphibian vehicle is based on the structure of existing vehicle, its airscrew module can be stored in an accommodating space of the triphibian vehicle. The self-power battery device can provide the unlimited power for the triphibian vehicle in a real time.

### B. The Description of the Related Art

The flying vehicle has multiple driving modes. In the land mode, the vehicle can drive forward without the need of the wings and only rely on the traction of the electric motor. As a kind of aircraft, a flying vehicle has the characteristics of vertical take-off and landing and hovering flight. In flight mode, the electric motor is required to provide a certain amount of lift and traction. In the other word, when the vehicle is flying in the air, it needs to use the wings to overcome the effect of gravity to maintain the flight state. When a vehicle is traveling on land, the volume of a vehicle with fixed wings is very large, which will hinder the driving. Therefore, the wing is an irreconcilable contradiction between the land and air modes of a flying vehicle. In addition, in terms of power consumption, when a vehicle is traveling on land, the power consumption is only used for driving, and for eVTOL with relatively small thrust and lift, most of the energy is consumed in maintaining lift.

The prior art does not teach the airscrew modules that can be stored in an accommodating space of the triphibian vehicle, and the prior art does not teach the triphibian vehicle has a self-power battery device.

### BRIEF DESCRIPTION OF THE INVENTION

The present invention is a triphibian vehicle based on the electric vehicle structure which can travel in land, water and air. The triphibian vehicle have three operating modes, that is the land mode, the air mode and the water mode, which can be converted to each other. At least one airscrew module assembly as a propeller is set up in the triphibian vehicle for traveling in air and water. The self-powered battery of the triphibian vehicle replaces the current rechargeable battery to reduce the weight of the vehicle. At least one accommodating space is set up in the triphibian vehicle for collecting the airscrew module to support the land work mode, so that when the triphibian vehicle travels in the land, it can be an ordinary electric car. The working mode of the vehicle can be determined by the position of the airscrew module assembly, and the mutual transformation of the three working modes is achieved by the position change of the airscrew module assembly. An airscrew module assembly is set up at the top of the triphibian vehicle to ensure a safe and stable flight. The triphibian vehicle as an aircraft, it can be vertical takeoff and landing for transporting people or objects.

In order to improve the safety and stability of the vehicle in the air, and to save more electricity and increase the flight mileage. At the same time, in order to reduce the size of the flying car when driving on land. The invention also provides a method and system in which the wing of vehicle is retractable and foldable. When the vehicle is in flight mode, the wing can be rotated or slid out of the accommodating space through the control system so that the vehicle generates lift force to counteract the effect of gravity, making the vehicle safer, effectively saving electricity and increasing flight mileage.

Bat wings are foldable. According to the principle of bionics, the present invention combines certain practical characteristics of automobiles and airplanes to form a unique wing design. At least one wing system is disposed on the vehicle body, the wing is retractable and foldable. At least one accommodating space is disposed on the vehicle body to store the wing system. The wing system is capable of rotating relative to the vehicle body to selectively rotate into or out of the accommodating space.

When the vehicle is in the land mode, the wings are stowed in the accommodating space to reduce the volume of the vehicle and reduce the air resistance when the vehicle is traveling. When the vehicle is in flight mode, the wing can be rotated or slid out of the accommodating space by the control of the control system so that the vehicle can obtain lift force with the aid of aerodynamic force to counter gravity, thereby saving electricity and increasing the flight mileage. When the vehicle is switched from the flight mode to the land mode, the wing can be rotated or slid into the accommodating space through the control of the control system. There is no restriction on the shape of the wing, and it can be designed into different shapes as long as it conforms to the principles of aerodynamics. In some embodiments, the wing may be inflated.

The accommodating space A vehicle has an accommodating space for storing the airscrew module assemblies at front and rear. The vehicle as an ordinary car travel in the land when the airscrew module assemblies are stored inside the accommodating space; when the airscrew module assembly rotates out of the accommodating space, the vehicle can travel in air or on water.

The Self-Powered Battery

The self-powered battery is a hydraulic battery or a magnetic power battery or a gravity battery that generates power using fluid pressure, which uninterruptedly converts the natural energy into electricity to provide unlimited power in areal time for the triphibian vehicle. The self-powered battery replaces the rechargeable battery to reduce the weight of the vehicle, increase the load capacity of the triphibian vehicle.

The Airscrew Module Assemblies

An airscrew module assembly comprises a propeller assembly, a retractable shaft assembly, and an extension arm member. Wherein, the propeller assembly includes at least one propeller blade and a motor, the retractable shaft assembly includes a retractable rod and a base with positioning holes and positioning screws. In some embodiments, the extension arm member can be an extension assembly. An airscrew module assembly is capable of rotating relative to the vehicle body to selectively rotate into or out of the accommodating space. When an airscrew module assembly is inside the accommodating space, the vehicle is in land mode; when an airscrew module assembly rotates out of the accommodating space, the vehicle is in air mode or water mode; Preferably, a propeller assembly is configured on the top of vehicle, it provides flight stability and safety for the vehicle.

Preferably, an airscrew module assembly may be configured with a module control system to make the airscrew module assembly rotate automatically into or out of the accommodating space. Further, a module control system may be coupled to different positions on the vehicle body.

In an embodiment, referring to FIGS. 1.1, 1.2 1.3 and 1.4, there are two first airscrew module assemblies 3 coupled to the accommodating space 1 of the vehicle body 100 and two second airscrew module assemblies 4 are coupled to the accommodating space 2 of the vehicle body 100, and one propeller assembly 5 coupled to the top of the vehicle body 100. Wherein, each airscrew module assembly includes an extension member 6 coupled to the retractable shaft assembly 7, a retractable shaft assembly 7 coupled to the vehicle body 100, and a propeller assembly 8 coupled to the extension arm member 6. Wherein a retractable shaft assembly 7 includes a retractable rod 7A and, a base 7B with positioning holes 7C and positioning screws 7D, and a propeller mold assembly 8 includes at least one propeller blade 8A and a motor 8B. Each airscrew module assembly is capable of rotating relative to the vehicle body to selectively rotate into or out of the accommodating spaces. When the propeller assembly 8 rotates horizontally, the lift provided by the propeller can make the vehicle take off and land vertically.

In another embodiment, referring to FIGS. 1.5, 1.6 and 1.7, the airscrew module assembly is disposed with wing 6A. The wing 6A is fixed on the extension member 6 and can move with the extension member 6. When the vehicle is in flight mode, the wing can use aerodynamic force to gain greater lift force to counter gravity, thereby reducing the energy required for the vehicle to fly and increasing the flight mileage.

It should be understood that the shape of the wing is not limited, but it should conform to the principles of aerodynamics. The material of the wing should be light, firm and rigid. Such as composite materials, alloy materials, carbon fiber, etc., but not limited to these materials.

In another embodiment, referring to FIGS. 4 and 4.1, the airscrew module assemblies are in water mode, two first airscrew module assemblies (not shown) and two second airscrew module assemblies rotate at an oblique or vertically level, the propulsion provided by the propeller allows the vehicle to travel in water.

In the present case, these components are illustrated in sketch form; for the concern of this invention is with the applicability of essentially the same modular structure to water and air vehicles, not with the structural details of the components.

Preferably, an airscrew module assembly may be configured with a module control system 9 to make the airscrew module assembly rotate automatically into or out of the accommodating space relative to the vehicle body. Further, a module control system may be coupled to different positions on the vehicle body.

The position of the airscrew module assembly is variable in the triphibian vehicle for travelling in air, land and water. The movement, rise, fall and the change in the rotation angle of the airscrew module assembly, all of which are achieved by the extension arm member, retractable shaft assembly and module control system. The conversion of the triphibian vehicles from land to air flight does not require any space, the module control system moves the position of the airscrew module to achieve the conversion mode of the triphibian vehicles. Air mode, when the airscrew module assembly moves out of the accommodating space, which can be as a propeller to allow the triphibian vehicle vertical takeoff and landing in land and traveling in water.

The triphibian vehicles can be autopilot and unmanned. As used in this document, the term “autopilot” means that the triphibian vehicle may take-off, fly and land under the control of an autopilot control system. As used in this document, the term “unmanned” means that the triphibian vehicle does not accommodate a human pilot, although a human operator may program the autopilot control system prior to flight, including selection of a mission plans, waypoints and a landing zone. During flight, a human operator also may select or change the mission plan, waypoints and landing point from a remote station or may control the airscrew module remotely.

Flight System

A flight system comprises at least one wing system, a frame with accommodating space, and a control system. A flight system can be installed on the bottom of the vehicle body, or on the top of the vehicle body, or on the top and bottom of the vehicle body at the same time. The flight system can increase the safety and stability of the aircraft in rainy, windy and strong airflow. When the aircraft needs to land in extreme weather, the flight system will effectively prevent the aircraft from falling too fast and other unsafe factors.

The frame with accommodating space is made of metal, which is used to store the wing system, so that it can reduce the resistance of the vehicle when driving on land; the frame is equipped with a shaft to connect the wing for the rotation of the wing; there are chutes on both sides of the frame, fixedly connected with the two ends of the wing, used for sliding the wing into or out of the accommodating space.

The wing of the wing system can be retractable or foldable, conforming to the aerodynamic structure. When the vehicle is in flight mode, the wing stowed in the accommodating space can be rotated or slid out of the vehicle body through the control of control system, so that the vehicle can obtain lift force to reduce the electric energy required in flight. There are holes in the wing, and bearings can be installed in the holes to reduce the frictional resistance when the wing rotates. The material of the wing should be light, firm and rigid. Such as composite materials, alloy materials, carbon fiber, etc., but not limited to these materials. In some embodiments, the wings are also inflatable. It should be understood that the shape of the wing is not limited, but it should conform to the principles of aerodynamics.

A wing system is capable of rotating or sliding relative to the vehicle body to selectively rotate or slide into or out, of the accommodating space. When the wing system is inside the accommodating space, the vehicle is in land mode; when the wing system rotates or slides out of the accommodating space, the vehicle is in flight mode.

In an embodiment, referring to FIGS. 7, 7.1, 7.2, 7.3 and 7.4, a flight system 20, wherein a wing system 20B is disposed on the frame with accommodating space 20A. A control system 20C is disposed on the wing system 20B to control the wings to selectively move into or out of the accommodating space relative to the vehicle body.

When the wing system is inside the accommodating space, the vehicle is in land mode; when the wing system rotates or slides out of the accommodating space, the vehicle is in flight mode. The wing system 20B can use aerodynamic force to gain greater lift force to counter gravity, thereby reducing the energy required for the vehicle to fly and increasing the flight mileage.

In the present case, these components are illustrated in sketch form; for the concern of this invention is with the applicability of essentially the same modular structure to water and air vehicles, not with the structural details of the components.

Another type of flight system A flight system comprises at least one wing system, a frame with accommodating space, and a control system. A flight system can be installed on the bottom of the vehicle body, or on the top of the vehicle body, or on the top and bottom of the vehicle body at the same time.

The frame with accommodating space is made of metal, which is used to store the wing system, so that it can reduce the resistance of the vehicle when driving on land. There are chutes on both sides of the frame for sliding the wings into or out of the containing space.

The wing of the wing system can be retractable or foldable, conforming to the aerodynamic structure. When the vehicle is in flight mode, the wing stowed in the accommodating space can be rotated or slid out of the vehicle body through the control of the control system, so that the vehicle can obtain lift force to reduce the electric energy required in flight. The material of the wing should be light, firm and rigid. Such as composite materials, alloy materials, carbon fiber, etc., but not limited to these materials. In some embodiments, the wings are also inflatable.

A wing system is capable of sliding relative to the vehicle body to selectively slide into or out of the accommodating space. When the wing system is inside the accommodating space, the vehicle is in land mode; when the wing system slides out of the accommodating space, the vehicle is in flight mode.

In an embodiment, referring to FIGS. 8, 8.1 and 8.2, a flight system 30, wherein a wing system 30B is disposed on the frame with accommodating space 30A. A control system 30C is disposed on the wing system 30B to control the wings to selectively move into or out of the accommodating space relative to the vehicle body.

When the wing system is inside the accommodating space, the vehicle is in land mode; when the wing system rotates or slides out of the accommodating space, the vehicle is in flight mode. The wing system 30B can use aerodynamic force to gain greater lift force to counter gravity, thereby reducing the energy required for the vehicle to fly and increasing the flight mileage.

In another embodiment, referring to FIG. 9, a flight system 40 includes multiple wing systems and control systems. The wing systems can selectively move into or out of the accommodating space relative to the vehicle body under the control of control system.

When the wing systems are inside the accommodating spaces, the vehicle is in land mode; when the wing system slides out of the accommodating spaces, the vehicle is in flight, mode. The wing system can use aerodynamic force to gain greater lift force to counter gravity, thereby reducing the energy required for the vehicle to fly and increasing the flight mileage.

It should be understood that the shape of the wing is not limited, but it should conform to the principles of aerodynamics. The material of the wing should be light, firm and rigid. Such as composite materials, alloy materials, carbon fiber, etc., but not limited to these materials. In some embodiments, the wings are also inflatable.

In the present case, these components are illustrated in sketch form; for the concern of this invention is with the applicability of essentially the same modular structure to water and air vehicles, not with the structural details of the components.

It should be understood that different types of flight systems can be combined and configured on the vehicle body.

Tail System

At least one tail system is disposed on the vehicle body, which is retractable and foldable. Tail system includes wing system, control system, propeller system, etc., but is not limited to these systems and components. It can also include other systems and components on the premise of conforming to the principles of aerodynamics.

When the vehicle is in land mod, the tail system is stored in the accommodating space; when vehicle is in flight mode, the wing system can be extended out of the accommodating space.

Ducted Fan

The airscrew module may use any configuration of known rotating wings in the field of aircraft to support aircraft in flight or to navigate in water. Optionally, the airsrew module is equipped with four conduit fans connected to the vehicle body. Each channel fan type includes a circular pipe around the rotor.

Land Mode

In an embodiment, the vehicle is in land mode. Referring to FIGS. 1.1, 1.2 1.3 and 1.4, two first airscrew module assemblies 3 coupled to the accommodating space 1 of the vehicle body 100, each first airscrew module assemblies includes an extension arm member 6, a retractable shaft assembly 7 and a propeller assembly 8; Two second airscrew module assemblies 4 coupled to the accommodating space 2 of the vehicle body 100, each second airscrew module assemblies includes an extension arm member 6, a retractable shaft assembly 7 and a propeller assembly 8; when the two first airscrew module assemblies 3 and the two second airscrew module assemblies 4 are respectively stored in the accommodating space 1 and the accommodating space 2, the vehicle is in land mode and is used on the road as an ordinary vehicle. Each airscrew module assembly is capable of rotating relative to the vehicle body to selectively rotate into or out of the accommodating spaces. Preferably, a propeller assembly 5 is configured on the top of vehicle, it provides flight stability and safety for the vehicle.

Preferably, an airscrew module assemblies may be configured with a module control system 9 to make the airscrew module assembly rotate automatically into or out of the accommodating space relative to the vehicle body.

In another embodiment, referring to FIGS. 1.5 and 1.6, a wing is disposed on the airscrew module assembly. Each airscrew module assembly with wing is capable of rotating relative to the vehicle body to selectively rotate into or out of the accommodating spaces. When vehicle is in land mod, the airscrew module assemblies with wings are stored in the accommodating spaces. The way of connection, conversion and working of each component in the land mode is the same as the above-mentioned embodiment. The description will not be repeated here.

In another embodiment, referring to FIGS. 7, 7.1, and 7.2, a flight system 20 comprises a frame with accommodating space 20A, the wing system 20B, and a control system 20C. The flight system is capable of rotating relative to the vehicle body to selectively rotate into or out of the accommodating spaces. Referring to FIGS. 7.3 and 7.4, the wing system of the wing system is retractable and foldable. The flight system is stored in the accommodating space to reduce the volume of the vehicle when the vehicle travels in the land.

In another embodiment, referring to FIGS. 8, 8.1, and 8.2, a flight system 30 comprises a frame, with accommodating space 30A, the wing system 30B, and a control system 30C. The flight system is capable of sliding relative to the vehicle body to selectively slide into or out of the accommodating spaces. The wing system of the wing system is retractable and foldable. The flight system is stored in the accommodating space to reduce the volume of the vehicle when the vehicle travels in the land.

In another embodiment, referring to FIG. 9, a flight system 40 comprises multiple the wing system, frame with accommodating space and control system (component number not shown). The flight systems are capable of sliding relative to the vehicle body to selectively slide into or out of the accommodating spaces. The wings system of the wing system is retractable and foldable. The flight systems are stored in the accommodating space to reduce the volume of the vehicle when the vehicle travels in the land.

In another embodiment, referring to FIG. 10, there are multiple flight systems are disposed on the vehicle body to increase flight safety and stability. The wing systems are stored in the accommodating spaces when the vehicle is traveling in land.

Air Mode

In an embodiment, the vehicle is in air mode. Referring to FIGS. 3 and 3.1, two first airscrew module assemblies 3 coupled to the accommodating space 1 of the vehicle body 100, each first airscrew module assemblies includes an extension arm member 6, a retractable shaft assembly 7 and a propeller assembly 8; Two second airscrew module assemblies 4 coupled to the accommodating space 2 of the vehicle body 100, each second airscrew module assemblies includes an extension arm member 6, a retractable shaft assembly 7 and a propeller assembly 8; while the two first airscrew module assemblies 3 and the two second airscrew module assemblies 4 are respectively rotated out of the accommodating space 1 and the accommodating space 2 and the propellers rotate horizontally, the vehicle is in flight mode, and the lift provided by the propeller allows the vehicle to directly take off and land vertically.

Preferably, a propeller assembly 5 is configured on the top of vehicle, it provides flight stability and safety for the vehicle.

Preferably, an airscrew module assemblies may be configured with a module control system 9 to make an airscrew module assembly rotate automatically into or out of the accommodating space relative to the vehicle body.

In another embodiment, referring to FIGS. 1.5, 1.6 and 1.7, the airscrew module assembly is disposed with wing. Each airscrew module assembly with wing, is capable of rotating relative to the vehicle body to selectively rotate into or out of the accommodating spaces. When the vehicle is in flight mode, the wing can use aerodynamic force to gain greater lift force to counter gravity, thereby reducing the energy required for the vehicle to fly and increasing the flight mileage.

The way of connection, conversion and working of each component in the flight mode is the same as the above-mentioned embodiment. The description will not be repeated here.

In another embodiment, referring to FIGS. 7, 7.1, and 7.2, a flight system 20 comprises a frame with accommodating space 20A, the wing system 20B, and a control system 20C. The flight system is capable of rotating relative to the vehicle body to selectively rotate into or out of the accommodating spaces. Referring to FIGS. 7.3 and 7.4, the wing system of the wing system is retractable and foldable. When the vehicle travels in the air, the flight system is slid out of the accommodating space through the control of control, system to increase lift force, save vehicle power, and increase flight mileage. Meanwhile, the flight system can increase the safety and stability of the aircraft in rainy, windy and strong airflow. When the aircraft needs to land in extreme weather, the flight system will effectively prevent the aircraft from falling too fast and other unsafe factors.

In another embodiment, referring to FIGS. 8, 8.1, and 8.2, a flight system 30 comprises a frame with accommodating space 30A, the wing system 30B, and a control system 30C. The flight system is capable of sliding relative to the vehicle body to selectively slide into or out of the accommodating spaces. The wing system of the wing system is retractable and foldable. The flight system is stored in the accommodating space to reduce the volume of the vehicle when the vehicle travels in the land.

In another embodiment, referring to FIG. 9, a flight system 40 comprises multiple the wing system, frame with accommodating space and control system (component number not shown). The wing systems are retractable and foldable and are capable of sliding relative to the vehicle body to selectively slide into or out of the accommodating spaces under the control of the control system. The wing systems are stored in the accommodating space to reduce the volume of the vehicle when the vehicle travels in the land.

In another embodiment, referring to FIG. 10, there are multiple flight systems are disposed on the vehicle body to increase flight safety and stability. The wing systems are slid out of the accommodating spaces by the control of the control system when the vehicle is traveling in the air.

It should be understood that different types of flight systems can be combined and disposed on the vehicle body.

Water Mode

In an embodiment, the vehicle is in water mode. Referring to FIGS. 4 and 4.1, two first airscrew module assemblies 3 coupled to the accommodating space 1 of the vehicle body 100 (not shown); Two second airscrew module assemblies 4 coupled to the accommodating space 2 of the vehicle, body 100, each first and second airscrew module assembly includes an extension arm assembly 6, a retractable shaft assembly 7 and a propeller assembly 8. The two first airscrew module assemblies 3 (not shown) and the two second airscrew module assemblies 4 respectively rotates out of the accommodating space 1 and the accommodating space 2, and at least one propeller rotates at an angle that is inclined or perpendicular to the horizontal plane, the driving force provided by the propeller can enable the vehicle to travel on water.

Preferably, an airscrew module assemblies may be configured with a module control system 9 to make an airscrew module assembly rotate automatically into or out of the accommodating space relative to the vehicle body.

The Propeller Assembly

A propeller assembly is arranged at the top of the center of the vehicle body, and the propeller assembly has at least two blades, which may have both working and non-working conditions. When the vehicle is in land mode, the blades are in a non-working state and the blades are folded horizontally or longitudinally on the vehicle body to reduce drag. On the contrary, when the vehicle is in air mode, the blades are in a working state they become a loose working condition, providing balance or up force for the triphibian vehicle or as a parachute for safe landing.

Vertical Takeoff and Landing

When the two first and second airscrew modules are outside the vehicle body which are in series connection or parallel connection, the triphibian vehicle enters the air mode, and the airscrew can provide vertical takeoff and landing when horizontally rotating.

Flight Control

When the triphibian vehicle is flying, the two second airscrew modules apply a reverse torque to the aircraft to control the flight direction by tilting at a certain angle of rotation.

The Autopilot Control System of the Triphibian Vehicle

The autopilot control system includes a microprocessor, a computer memory, a sensor, and a control effector. The autopilot control system allows the task plan to be pre-programmed into the computer's memory, including the waypoint and landing location. The operator may change the mission plan, waypoint, or landing location during the flight.

### BRIEF DESCRIPTION OF THE DRAWINGS

FIG. 1 is a schematic view of the position of accommodating space 1, an accommodating space 2, an airscrew module assembly 3, an airscrew module assembly 4 and a propeller assembly 5 in a land mode of the vehicle; FIG. 1.1 shows in sketch form an essential airscrew module assembly in accordance with the invention; FIG. 1.2 shows an assembled structure of an airscrew module assembly; FIG. 1.3 illustrates a land mode of a vehicle which incorporates the modular structure; FIG. 1.4 is a schematic view showing the connection between a module control system and an airscrew module assembly at different positions. According to the needs of different modes of a vehicle, an airscrew module assembly can be configured in different positions on a module FIG. 1.5 shows an assembled structure of an airscrew module assembly with a wing 6A; the wing 6A is disposed on the extension arm member 6.

FIG. 1.6 illustrates a land mode of a vehicle which incorporates the modular structure with wings; the airscrew assemblies with wings are stored in the accommodating spaces.

FIG. 1.7 illustrates an air mode of vehicle which incorporates the modular structure with wings. The airscrew module assemblies with wings rotate out of the accommodating space to reach a predetermined position, and the vehicle is in flight mode.

FIG. 2 is a schematic view of a vehicle as an ordinary vehicle traveling in land, an airscrew assembly 5 is disposed on the top of vehicle body 100 for safety purpose.

FIG. 3 is a schematic diagram of an air mode of the vehicle, wherein the airscrew module assemblies 3 and the airscrew module assemblies 4 respectively rotate out of the accommodating space; the retractable shafts 7 are coupled to the vehicle body, the extension arms member 6 are connected to the retractable shafts 7, and the propeller assemblies 8 are coupled to the extension arms member 6, the propeller assembly 5 is disposed on the top of vehicle body 100; the propeller assemblies 8 and the propeller assembly 5 rotate horizontally. FIG. 3.1 illustrates an air mode of vehicle which incorporates the modular structure. The airscrew module assemblies rotate out of the accommodating space to reach a predetermined position, and the vehicle is in flight mode.

FIG. 4 is a schematic view of the water mode of vehicle, the airscrew module assemblies 4 vertically rotate to push the operation of the vehicle 100, wherein the airscrew module assemblies 4 rotate out of the accommodating space to reach a predetermined position, the airscrew assembly 5 is coupled to the top of the vehicle body 100 and secured parallelly relative to the vehicle body, and the airscrew module assemblies 4 include an extension arm assembly 6, a retractable shaft 7 and a propeller assembly 8; the retractable shaft 7 are coupled to the vehicle body 100, the extension arm assembly 6 is connected to the retractable shaft 7, propeller assembly 8 is coupled to the extension arm assembly 6; the airscrew module assemblies rotate out of the accommodating space to reach a predetermined position. FIG. 4.1 shows assembled structure of an airscrew module assembly in water mode. Wherein the extension arm assembly 6 are connected to the retractable shaft 7, and the propeller assembly 8 are coupled on the extension arm assembly 6, and the propeller rotates vertically to provide propulsion for the vehicle so that the vehicle can travel in water.

FIG. 5 is schematic view of at least two airscrew module assemblies being respectively disposed at the front and back of the vehicle. FIG. 5.1 is a view of the airscrew module assemblies being disposed at the rear of the vehicle; the accommodating space is open without a cover. The airscrew module assemblies being disposed at the front of the vehicle is not shown.

FIG. 6 is schematic view of at least two airscrew module assemblies being respectively disposed on the left side and right side of the vehicle. FIG. 6.1 is schematic view of at least one airscrew module assembly being disposed on each side of the vehicle in land mode. FIG. 6.2 is schematic view of at least one airscrew module assembly being disposed on each side of the vehicle in air mode or water mode. FIG. 6.3 is a side view of the airscrew module assembly stored in different positions on the side of vehicle body in land mode.

FIG. 7 is a schematic view showing a flight system of the vehicle; FIG. 7.1 shows an assembled structure of a wing system and a frame; FIG. 7.2 is a schematic view showing an assembled structure of a flight system, the wings are capable of sliding relative to the vehicle to selectively slide into or out of the accommodating space under the control of a control system;

FIG. 7.3 is a schematic view showing a wing that is retractable and foldable; FIG. 7.4 is a schematic view showing another type of wing that is retractable and foldable.

FIG. 8 is a schematic view showing a vehicle in a flight mode, the wings slide out of the accommodating space under the control of the control system when the vehicle travels in the air;

FIG. 8.1 is a schematic view showing an assembled structure of a flight system, the wings are capable of sliding relative to the vehicle to selectively slide into or out of the accommodating space under the control of control system; FIG. 8.2 a schematic view showing a flight system is installed to the bottom of the vehicle. The wings can be retractable and foldable.

FIG. 9 is a schematic view showing another a flight system. The wings can be retractable and foldable. The wings are capable of sliding relative to the vehicle to selectively slide into or out of the accommodating space.

FIG. 10 is a schematic view showing a plurality of flight systems respectively is disposed on the top of the vehicle and the bottom of the vehicle. The wings are retractable and foldable and are capable of sliding relative to the vehicle to selectively slide into or out of the accommodating space.

### DESCRIPTION OF AN EMBODIMENT

The present invention is a triphibian vehicle that can travel in land, water and air, comprising a basic structural feature of an existing automobile, which is characterized in that at least one of the said airscrew module driven by electric power in the triphibian vehicle, and the three transport functions of the land, air, and water modes are achieved by the airscrew modules at various positions. The triphibian vehicle is powered by a self-powered battery to provide unlimited mileage to reduce the need for many rechargeable batteries, achieving the purpose of reducing the weight of the vehicle, obtaining the maximum up force and carrying capacity.

According to an embodiment, the disclosure provides a vehicle. The vehicle includes a self-powered battery (not shown) is coupled to the vehicle body 100, two first airscrew module assemblies 3 are coupled to the accommodating space 1 at the front of the vehicle body and two second airscrew module assemblies 4 are coupled to the accommodating space 2 at the rear of the vehicle body; each airscrew module assembly includes a retractable shaft assembly 7 coupled to the vehicle body 100, an extension arm member 6 coupled to the retractable shaft assembly 7 and a propeller assembly 8 coupled to the extension arm member 6; wherein a propeller assembly 8 has at least one blade; a propeller assembly 5 is coupled to the top of the vehicle body 100 and the blades of the propeller is secured laterally or longitudinally to reduce wind resistance in land mode. It should be understood that the blades of the propeller assembly 8 can be folded and other forms, the purpose is to make the blades fit into accommodating space, so as not to affect the exercise of the vehicle on the road.

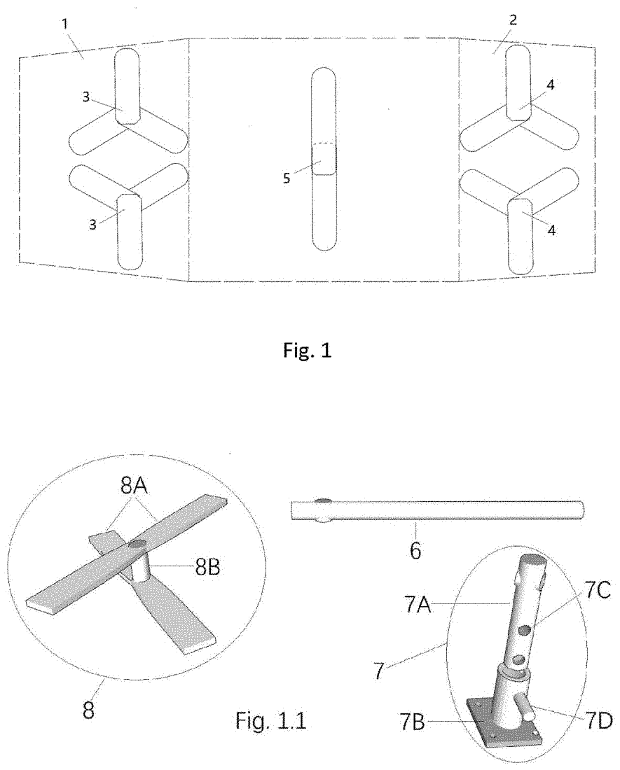

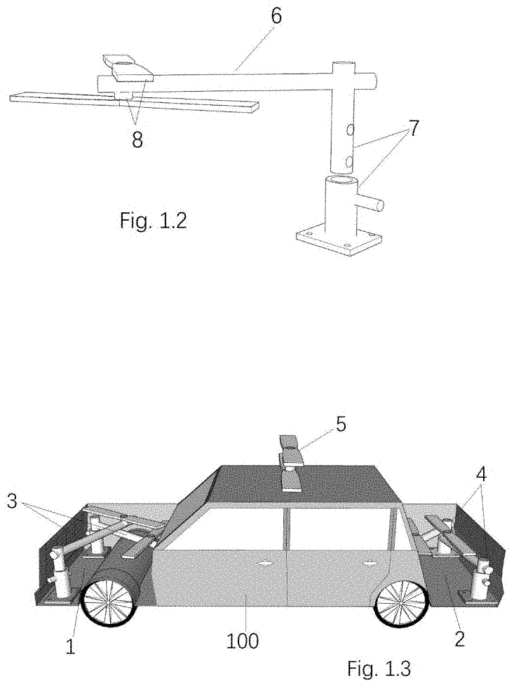

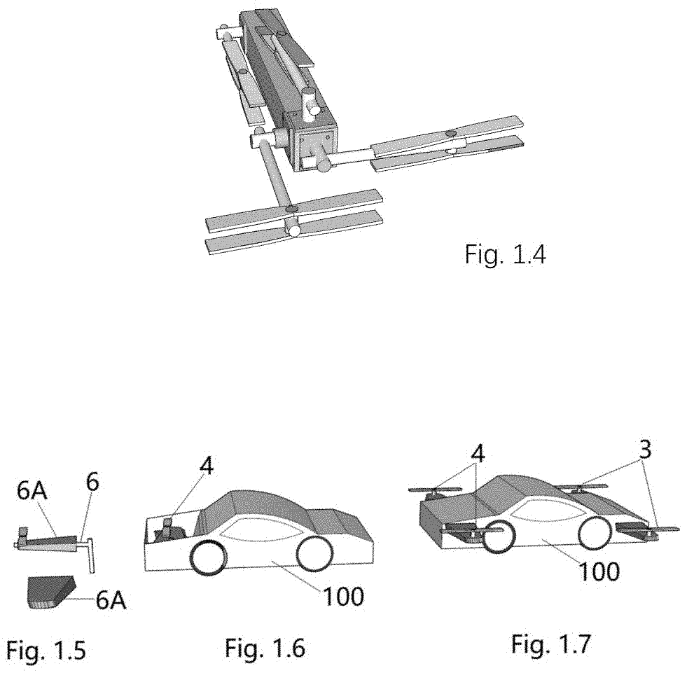

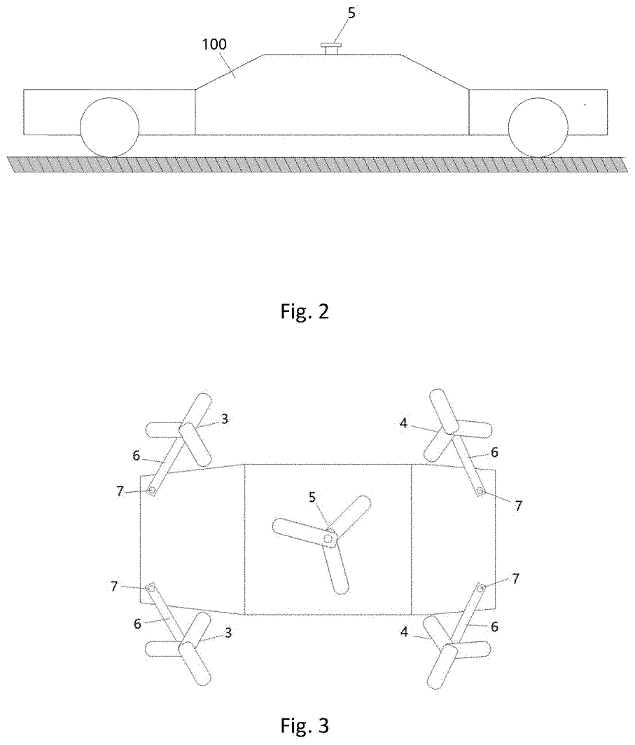

Further, refer to FIG. 1.4, preferably, a module control system can be configured on an airscrew module assembly. An airscrew module assembly can be coupled to the different positions on a module control system. So that the airscrew module assemblies can be automatically controlled.

How the Triphibian Vehicle Works:

Land Mode:

According to an embodiment, referring to 1.1 to 1.4, the disclosure provides a vehicle. The vehicle includes two first airscrew module assemblies 3 and two second airscrew module assemblies 4 are respectively housed in accommodating space 1 and accommodating space 2 of the vehicle body 100, they are in a non-working state, at this time the vehicle is a general vehicle; The blade of the safety airscrew assembly 5 is configured to the top of the vehicle body 100; The self-powered battery provides power to the motor, and then the motor drives the hub to allow the triphibian vehicle traveling in land.

Referring to FIGS. 1.1 to 1.4, taking the first airscrew module assembly 3 stored in the accommodating space 1 as an example, the first airscrew module assembly 3 comprises a retractable shaft assembly 7, an extension arm member 6, and a propeller assembly 8 having at least one blade, wherein the airscrew module assembly is capable of rotating relative to the vehicle body to selectively rotate into or out of the accommodating space; the retractable shaft assembly 7 is coupled to the vehicle body 100, wherein the retractable shaft assembly 7 comprises a retractable rod 7A and a base 7B. The retractable rod 7A can be raised, lowered and rotatable. The base 7B has some positioning holes 7C and a positioning screw 7D. The positioning screw 7D is used to fix retractable rod 7A at a predetermined height; The extension arm member 6 is coupled to the rotatable retractable shaft assembly 7, and the propeller assembly 8 is coupled to the extension arm member 6; As shown in FIG. 1.3, two first airscrew module assemblies 3 stored in the accommodating space 1. The propeller assembly 5 is coupled to the top of the vehicle.

Further, the structure, connection and installation of the second airscrew module assembly 4 stored in the accommodating space 2 are the same as those of the first airscrew module assembly 3 described above.

Further, preferably, a module control system can be configured on an airscrew module assembly, so that an airscrew module assembly can be automatically controlled.

Air Mode:

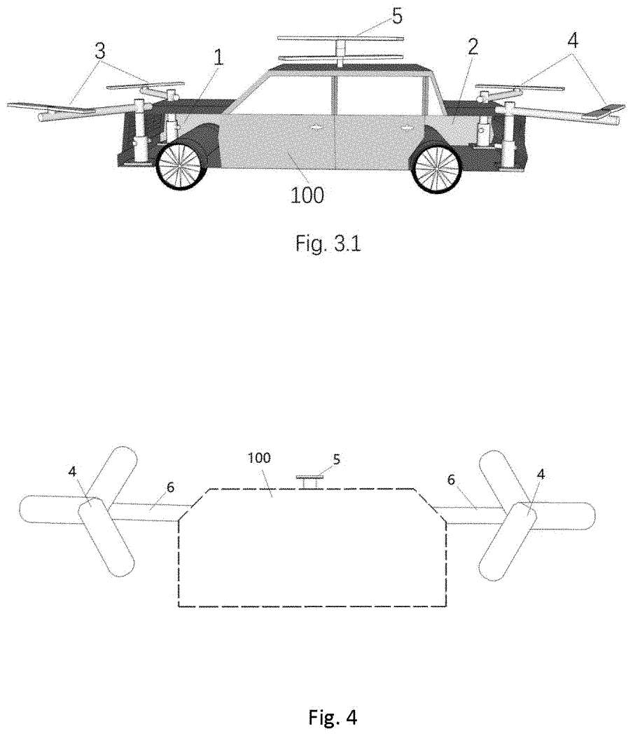

According to one embodiment, the disclosure provides the following steps for the vehicle to switch from land mode to flight mode. An air mode illustrated in FIG. 3.1. Open the covers of the accommodating space 1 and 2 respectively, adjust the four retractable shaft assemblies 7 to a predetermined height, then fix them with the positioning screws 7D, and move the four extension arm members 6 having the propeller assemblies 8 out of the accommodating spaces 1 and 2, when reaching an optimal flight position relative to the vehicle body and stop, the blades of the propeller assemblies 8 will rotate horizontally, unlock the blades of the propeller assembly 5 to make it rotatable, and supply power to the propeller motor, the blades of the propeller assemblies 8 and the blades of the propeller assembly 5 start to rotate to provide ascending power, and the vehicle is switched from land mode to flight mode. Referring to FIG. 3.1, the four airscrew module assemblies 3 and 4 rotate out of accommodating space, so that the vehicle can fly in the air.

Further, preferably, a module control system can be configured on an airscrew module assembly and a propeller assembly 5, so that an airscrew module assembly and a propeller assembly can be automatically controlled.

Water Mode:

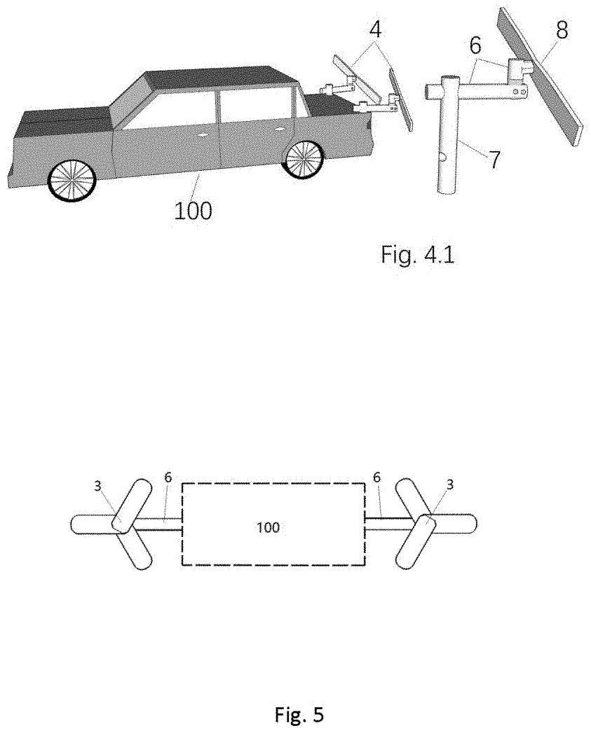

According to one embodiment, the disclosure provides the following steps for the vehicle to switch from land mode to water mode. Open the covers of the accommodating space 1 and 2 respectively, adjust the four retractable shaft assemblies 7 to a predetermined height, then fix them with the positioning screws 7D, and move the four extension arm assemblies 6 having the propeller assemblies 8 out of the accommodating spaces 1 and 2, when reaching an optimal operating position relative to the vehicle body and stop, and adjust the extension arm assemblies 6 to make the propeller assemblies 8 rotate vertically, lock the blades of the safety propeller module 5, and supply power to the propeller motor, the blades of the propeller assemblies 8 start to rotate vertically to provide forward power, close the cover and the vehicle is switched from land mode to water mode and ready to travel in water. Referring to FIG. 4.1, the four airscrew module assemblies 3 and 4 are rotated out of accommodating space, and so that the vehicle can travel in water.

Further, preferably, a module control system can be configured on an airscrew module assembly and a safety propeller module, so that an airscrew module assembly and a propeller assembly 5 can be automatically controlled.

Air Mode to Land Mode

According to an embodiment, the disclosure provides the following steps for the vehicle to switch from air mode to land mode. Open the covers of the accommodating space 1 and 2 respectively; move the four extension arms 6 having the propeller assemblies 8 into the accommodating spaces 1 and 2; adjust the propeller assemblies 8 to fit for the accommodating spaces; lower the four retractable shaft assemblies 7, then fix them with the positioning screws 7D; close the cover and lock the blades of the safety propeller module 5, and the vehicle is switched from air mode to land mode.

Further, preferably, a module control system may be configured on an airscrew module assembly and a safety propeller module, so that an airscrew module assembly and a safety propeller module can be automatically controlled.

Water Mode to Land Mode

According to an embodiment, the disclosure provides the following steps for the vehicle to switch from water mode to land mode. Open the covers of the accommodating space 1 and 2 respectively; move the four extension arm member 6 having the propeller assemblies 8 into the accommodating spaces 1 and 2; adjust the propeller assemblies 8 to fit for the accommodating spaces; lower the four retractable shaft assemblies 7, then fix them with the positioning screws 7D; close the cover and lock the blades of the safety propeller module 5, and the vehicle is switched from air mode to land mode.

Further, preferably, a module control system may be configured on an airscrew module assembly and a safety propeller module, so that an airscrew module assembly and a safety propeller module can be automatically controlled.

Water Mode to Air Mode

The disclosure provides the following steps for the vehicle to switch from water mode to air mode. Unlock the blades of the propeller assembly 5 to make it rotatable, and adjust the propeller assemblies 8 to switch from vertical rotation to horizontal rotation to provide ascending power, so that the vehicle is switched from water mode to air mode and the vehicle can fly in the air.

Air Mode to Water Mode

The disclosure provides the following steps for the vehicle to switch from air mode to water mode. Lock the blades of the propeller assembly 5, and adjust the propeller assemblies 8 to switch from horizontal rotation to vertical rotation to provide forward power, so that the vehicle is switched from air mode to water mode and the vehicle can travel on the water.

Further, preferably, a module control system can be configured on an airscrew module assembly and a safety propeller module, so that an airscrew module assembly and a safety propeller module can be automatically controlled.

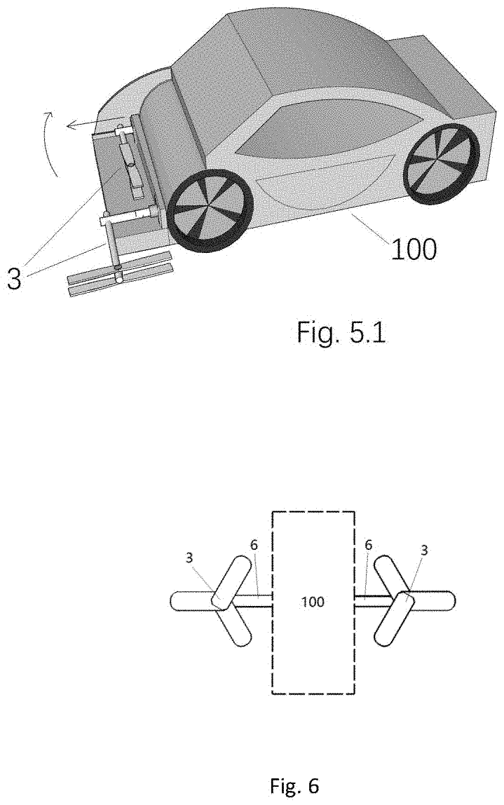

As shown in FIG. 5, at least two airscrew module assemblies are configurated in the vehicle body in embodiment B.

According to an embodiment, referring to FIGS. 5 and 5.1, the disclosure provides a vehicle. The vehicle includes a self-powered battery (not shown) is coupled to the vehicle body 100, the accommodating spaces 1 and 2 are respectively disposed at the front and rear of the vehicle body 100. The accommodating spaces are open, without the covers; two airscrew module assemblies are respectively disposed at the accommodating spaces 1 and 2; each airscrew module assembly includes a retractable shaft assembly 7 coupled to the vehicle body 100 (not shown), an extension arm member 6 coupled to the retractable shaft assembly 7 and a propeller assembly 8 coupled to the extension arm member 6; wherein a propeller assembly 8 has at least one blade; optionally, a propeller assembly 5 is coupled to the top of the vehicle body 100 (not shown) and the blades of the propeller is secured laterally or longitudinally to reduce wind resistance in land mode. It should be understood that the blades of the propeller assembly 8 can be folded and other forms, the purpose is to make the blades fit into accommodating space, so as not to affect the exercise of the vehicle on the road.

Further, preferably, an airscrew module assembly may be disposed with a modular control system to control a movement of the airscrew module assembly; wherein the airscrew module assemblies may be disposed at different positions on the modular control system.

How the Triphibian Vehicle Works:

Air Mode:

According to an embodiment, the disclosure provides the following steps for the vehicle to switch from land mode to air mode. Referring FIG. 5.1, taking the airscrew module assemblies 3 at rear of vehicle as an example: adjust the retractable shaft assemblies 7 to a predetermined position, then fix them with the positioning screws 7D (not shown), and move the extension arm member 6 having the propeller assemblies 8 out of the accommodating spaces, when reaching an optimal flight position relative to the vehicle body and stop, the propeller assemblies 8 will rotate horizontally, unlock the blades of the safety propeller module 5 to make it rotatable (not shown), and supply power to the propeller motor, the propeller assemblies 8 and the safety propeller module 5 start to rotate to provide ascending power, and the vehicle is switched from land mode to flight mode. So that the vehicle can fly in the air.

Further, preferably, a module control system may be configured on an airscrew module assembly and a safety propeller module, so that an airscrew module assembly and a safety propeller module can be automatically controlled.

Water Mode:

According to an embodiment, the disclosure provides the following steps for the vehicle to switch from land mode to water mode. Referring FIG. 5.1, taking the airscrew module assemblies 3 at rear of vehicle as an example: adjust the retractable shaft assemblies 7 to a predetermined position, then fix them with the positioning screws 7D (not shown), and move the extension arm member 6 having the propeller assemblies 8 out of the accommodating spaces, when reaching an optimal position relative to the vehicle body and stop, adjust the propeller assemblies 8 to make the blades rotate vertically to provide forward power, the vehicle is switched from land mode to water mode traveling in water.

Further, preferably, a module control system may be configured on an airscrew module assembly, so that an airscrew module assembly can be automatically controlled.

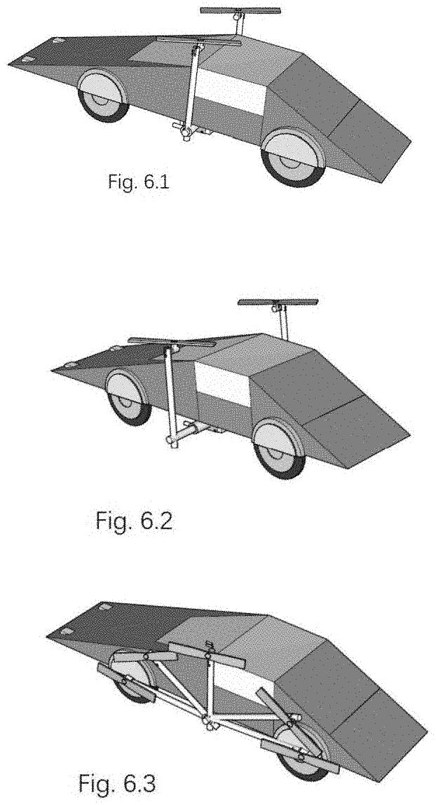

As shown in FIG. 6, at least two airscrew module assemblies are configurated in the vehicle body in embodiment C.

According to an embodiment, referring to FIGS. 6 and 6.1, the disclosure provides a vehicle. The vehicle includes a self-powered battery (not shown) is coupled to the vehicle body 100; two airscrew module assemblies are respectively disposed at both left and right side of vehicle body; each airscrew module assembly includes a retractable shaft assembly 7 (not shown) coupled to the vehicle body 100, an extension arm member 6 (not shown) coupled to the retractable shaft assembly 7 and a propeller assembly 8 (not shown) coupled to the extension arm member 6 (not shown); wherein a propeller assembly 8 has at least one blade; optionally, a propeller assembly 5 is coupled to the top of the vehicle body 100 (not shown) and the blades of the propeller is secured laterally or longitudinally to reduce wind resistance in land mode. It should be understood that the blades of the propeller assembly 8 may be folded and other forms, so as not to affect the exercise of the vehicle on the road.

Further, preferably, an airscrew module assembly may be disposed with a modular control system to control a movement of the airscrew module assembly; wherein the airscrew module assemblies may be disposed at different positions on the modular control system.

Air Mode:

According to an embodiment, the disclosure provides the following steps for the vehicle to switch from land mode to air mode. Referring FIGS. 6.1, 6.2 and 6.3, adjust the retractable shaft assemblies 7 to a predetermined position, then fix them with the positioning screws 7D (not shown), and move out the extension arm member 6 relative to the vehicle body to reach an optimal flight position and stop, the propeller assemblies 8 rotate horizontally, and supply power to the propeller motor, the propeller assemblies 8 starts to rotate to provide ascending power, and the vehicle is switched from land mode to flight mode. So that the vehicle can fly in the air.

Further, preferably, a module control system may be configured on an airscrew module assembly and a safety propeller module, so that an airscrew module assembly and a safety propeller module can be automatically controlled.

Water Mode:

According to an embodiment, the disclosure provides the following steps for the vehicle to switch from land mode to water mode. Referring FIGS. 6.1, 6.2 and 6.3, adjust the retractable shaft assemblies 7 to a predetermined position, then fix them with the positioning screws 7D (not shown), and move out the extension arm member 6 relative to the vehicle body to reach an optimal flight position and stop, the propeller assemblies 8 rotates vertically to provide forward power, the vehicle is switched from land mode to water mode traveling in the water.

Further, preferably, a module control system may be configured on an airscrew module assembly, so that an airscrew module assembly can be automatically controlled.

According to an embodiment, referring to FIG. 1.5, the disclosure provides a flight system. An airscrew module assembly is disposed with at least one wing 6A. The wing 6A is fixed on the extension member 6 and moves with the extension member 6. As shown in FIGS. 1.6 and 1.7, when the vehicle is in flight mode, the airscrew module assemblies with wings can be rotated out of accommodating space to gain greater lift force to counter gravity, thereby reducing the energy required for the vehicle to fly and increasing the flight mileage; when the vehicle is in land mode, the airscrew module assemblies with wings are stored in the accommodating spaces to reduce the volume of the vehicle and make it easier for the vehicle to travel on land.

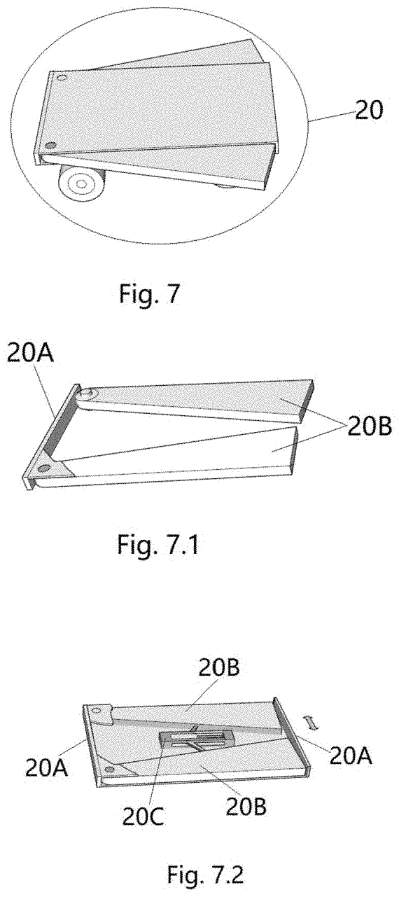

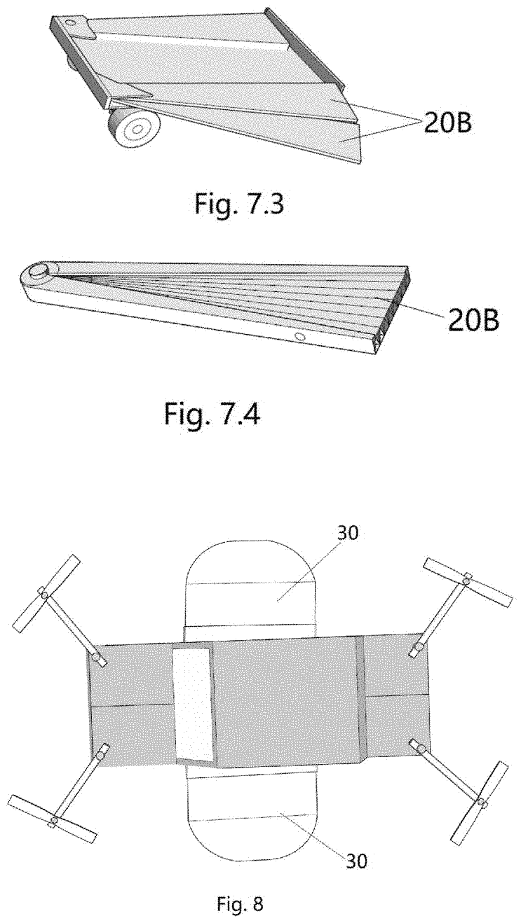

According to an embodiment, referring to FIG. 7, the disclosure provides a flight system. As shown in FIGS. 7.1 and 7.2, a flight system 20 comprises a frame with accommodating space 20A, at least one wing system 20B and a control system 20C. Wherein the wing system 20B is disposed on the frame 20A, there is hole and rod on the wing system 20B so that the wing system can rotate; the control system 20C is disposed on the wing system 20B. As shown in FIGS. 7.3 and 7.4, the wing can be retractable and foldable. The wings are capable of rotating relative to the vehicle body 100 (not shown) to selectively rotate into or out of the accommodating space under the control of control system 20C. When the vehicle travels in the air, the wings are capable to rotate out of the accommodating to increase lift force, flight safety, and flight mileage. When the vehicle is traveling on land, the wings are stored in the accommodating space to reduce the volume of the vehicle and make it easier for the vehicle to travel on land.

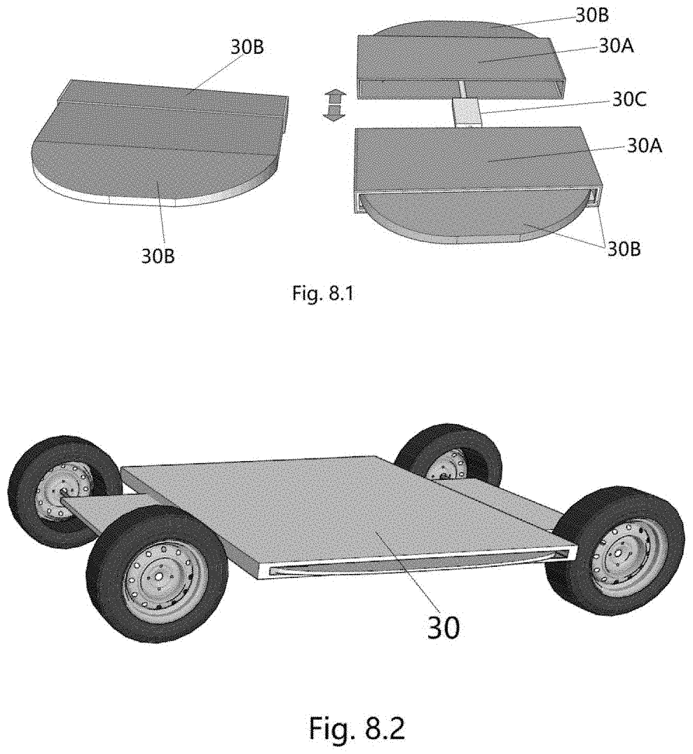

According to an embodiment, referring to FIG. 8, the disclosure provides another flight system. As shown in FIGS. 8.1 and 8.2, a flight system 30 comprises a frame with accommodating space 30A, a wing system 30B and a control system 30C. Wherein a wing system 30B is disposed on the frame 30A, the frame has chutes to allow the wing system to slide in or out of the accommodating spaces; the control system 30C is disposed on the wing system 30B. The wings are capable of sliding relative to the vehicle body 100 (not shown) to selectively slide into or out of the accommodating space under the control of control system 30C. The wing can be retractable and foldable. When the vehicle travels in the air, the wings are capable to slide out of the accommodating to increase lift force, flight safety and flight mileage. When the vehicle is traveling on land, the wings are stored in the accommodating space to reduce the volume of the vehicle and make it easier for the vehicle to travel on land.

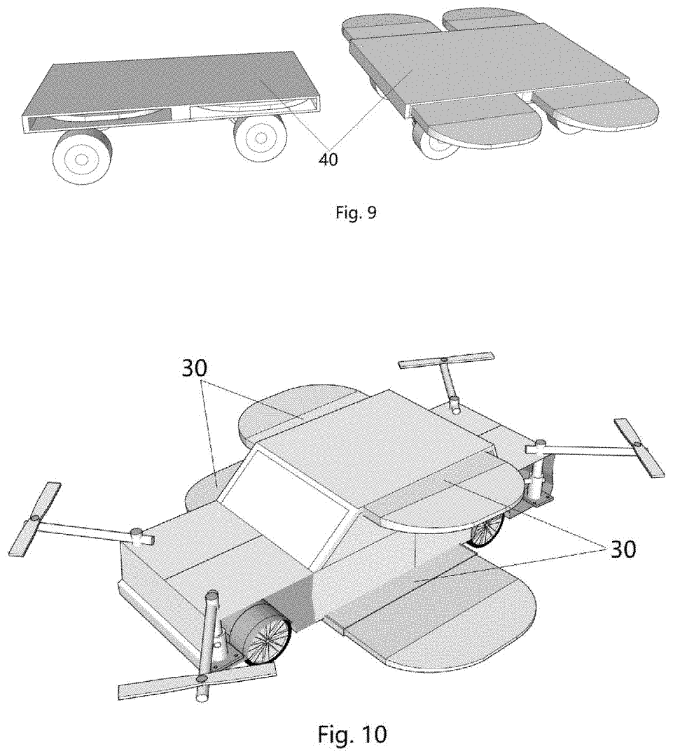

According to another embodiment, referring to FIG. 9, the disclosure provides a flight system 40, a flight system comprises a frame with accommodating space, a wing system and a control system (component structure not shown). The wings are capable of sliding relative to the vehicle body 100 (not shown) to selectively slide into or out of the accommodating space under the control of control system. The wing can be retractable and foldable. When the vehicle travels in the air, the wings are capable to slide out of the accommodating space to increase lift force, flight safety and flight mileage. When the vehicle is traveling on land, the wings are stored in the accommodating space to reduce the volume of the vehicle and make it easier for the vehicle to travel on land.

According to an embodiment, referring to FIG. 10, a plurality of flight systems 40 respectively is disposed on the top of the vehicle and the bottom of the vehicle. The wings are capable of sliding relative to the vehicle to selectively slide into or out of the accommodating space under the control of control system. The wings can be retractable and foldable. When the vehicle travels in the air, the wings are capable to slide out of the accommodating space to increase lift force, flight safety and flight mileage. When the vehicle is traveling on land, the wings are stored in the accommodating space to reduce the volume of the vehicle and make it easier for the vehicle to travel on land.

It should be understood that the shape of the wing is not limited, but it should conform to the principles of aerodynamics. The material of the wing should be light, firm and rigid. Such as composite materials, alloy materials, carbon fiber, etc., but not limited to these materials.

A method for converting the triphibian hybrid transportation tool between water mode, land mode and air mode in traveling, the method comprises the following steps of interchange conversion: 1) a land mode in which the triphibian vehicle is driven by an electric motor, and the first and second airscrew modules assemblies are housed in the first and second accommodating spaces of the triphibian vehicle, so as not to affect the vehicle traveling in the land and the structure of the vehicle; 2) the steps of converting land mode to air mode: open the cover, adjust the retractable shaft assembly, move the extension arm member having the propeller assembly out of the accommodating space to obtain the up force, the triphibian vehicle is lifted to achieve the purpose of vertical take-off or traveling in water and the third safety module is deployed from the overlapping land pattern to the flight mode to provide lift and balance and guarantee Safety;

3) converting the land mode to the water mode, the third safety airscrew module is contracted from the unfolded state to an overlapping state, the two first and second airscrew modules are stretched in the direction of the extension axis so that the radius of rotation of the vertical ground of the two first and second airscrew modules is higher than the water surface and rotated from the horizontal rotation angle to the angle perpendicular to the horizontal plane, that is, the propeller assembly is vertically rotated by a horizontal rotation to a airscrew module; 4) converting water mode or flight mode to land mode: move the two first and second airscrew modules assembly into the first and the second accommodating space of the triphibian vehicle, and close the hatch cover so that the triphibian vehicle becomes an ordinary vehicle.

The present application is characterized by 1) the triphibian vehicle is based on the structure of the ordinary car to achieve a hybrid vehicle function; 2) use the front and rear space of the triphibian vehicle body to collect the airscrew module assembly for traveling in water and air; 3) the function of the land mode, air mode and water mode are achieved by the position change of the propeller module, so that the triphibian vehicle can have a variety of ways of transport capacity; 4) the triphibian vehicle does not require the runway, which can be vertical takeoff and landing; 5. the triphibian vehicle is supplied directly from the self-powered battery with unlimited power, eliminating the need for charging and no mileage restrictions.

Several embodiments of the present invention have been described. It should be understood, however, that various modifications may be made without departing from the spirit and scope of the invention.

The foregoing description relates to what is presently considered to be the most practical embodiments. It is to be understood, however, that the present disclosure is not limited to these embodiments, but, on the contrary, is intended to cover various modifications and equivalent arrangements included within the spirit and scope of the appended claims, which is within the broadest interpretation, as permitted by law to include all such modifications and equivalent structures.

1. A vehicle, such as a land and an air, comprising:
a vehicle body having at least one accommodating space;
a battery power supply system;
at least one airscrew module assembly with wing coupled to the vehicle body, the airscrew module assembly with wing comprising:
a retractable shaft assembly;
an extension arm member coupled to the retractable shaft assembly;
at least one wing coupled to the extension arm member;
a propeller assembly coupled to the extension arm member;
wherein the airscrew module assembly with wing is capable of rotating relative to the vehicle body to selectively rotate into or out of the accommodating space.

2. The vehicle of claim 1, further comprising a plurality of the airscrew module assemblies with wing, wherein the vehicle body further has a plurality of the accommodating spaces respectively corresponding to the airscrew module assemblies with wing, and each of the airscrew module assemblies with wing is capable of rotating relative to the vehicle body to selectively rotate into or out of the corresponding accommodating space.

3. The vehicle of claim 1, the propeller assembly further comprising at least one propeller and an electrical motor, wherein the propeller coupled to the electrical motor and the electrical motor coupled to the extension arm member.

4. The vehicle of claim 1, the retractable shaft assembly further comprising a retractable rod and a base, wherein the base has at least one positioning hole and at least one positioning screw.

5. The vehicle of claim 1, wherein the airscrew module assembly with wing is optionally disposed with a modular control system to control a movement of the airscrew module assembly with wing; wherein the airscrew module assemblies with wing may be disposed at different positions on the modular control system.

6. The vehicle of claim 1, wherein the extension arm member may be an assembly structure having at least one wing that is disposed on the extension arm member and can move therewith.

7. The vehicle of claim 1, wherein the shape of the wing is not limited, and can be of different shapes under the premise of conforming to the principle of aerodynamics.

8. The vehicle of claim 1, wherein a propeller assembly is optionally disposed on the top of the vehicle.

9. A vehicle, such as a land and an air, comprising:
a vehicle body having at least one accommodating space;
a battery power supply system;
at least one airscrew module assembly coupled to the vehicle body, the airscrew module assembly comprising:
a retractable shaft assembly;
an extension arm member coupled to the retractable shaft assembly; and
a propeller assembly coupled to the extension arm member;
at least one flight system coupled to the vehicle body, the flight system comprising:
at least one wing system;
at least one frame with accommodating space to store the wing system; and
at least one control system controls the wing system to selectively rotate into or out of the accommodating space;
wherein the airscrew module assembly is capable of rotating relative to the vehicle body to selectively rotate into or out of the accommodating space; the wing system in the flight system is capable of rotating relative to the vehicle body to selectively rotate into or out of the accommodating space under the control of the control system.

10. The vehicle of claim 9, further comprising a plurality of the airscrew module assemblies, wherein the vehicle body further has a plurality of the accommodating spaces respectively corresponding to the airscrew module assemblies, and each of the airscrew module assemblies is capable of rotating relative to the vehicle body to selectively rotate into or out of the corresponding accommodating space.

11. The vehicle of claim 9, further comprising a plurality of the flight system is disposed on the vehicle body, and each of the wing system in the flight system is capable of rotating relative to the vehicle body to selectively rotate into or out of the corresponding accommodating space.

12. The vehicle of claim 9, wherein the material of the wing should be light, firm and rigid. Such as composite materials, alloy materials, carbon fiber, etc., but not limited to these materials.

13. The vehicle of claim 9, wherein the wing is retractable and foldable, and the shape of the wing is not limited, and can be of different shapes under the premise of conforming to the principle of aerodynamics.

14. The vehicle of claim 9, wherein the flight system may be disposed at different positions on the vehicle body, such as the bottom of the vehicle, the top of the vehicle, the rear of the vehicle, but not limited to these positions.

15. A vehicle, such as a land and an air, comprising:
a vehicle body having at least one accommodating space;
a battery power supply system;
at least one airscrew module assembly coupled to the vehicle body, the airscrew module assembly comprising:
a retractable shaft assembly;
an extension arm member coupled to the retractable shaft assembly; and
a propeller assembly coupled to the extension arm member;
at least one flight system coupled to the vehicle body, the flight system comprising:
at least one wing system;
at least one frame with accommodating space to store the wing system; and
at least one control system controls the wing system to selectively slide into or out of the accommodating space;
wherein the airscrew module assembly is capable of rotating relative to the vehicle body to selectively rotate into or out of the accommodating space; the wing system in the flight system is capable of sliding relative to the vehicle body to selectively sliding into or out of the accommodating space under the control of the control system.

16. The vehicle of claim 15, further comprising a plurality of the airscrew module assemblies, wherein the vehicle body further has a plurality of the accommodating spaces respectively corresponding to the airscrew module assemblies, and each of the airscrew module assemblies is capable of rotating relative to the vehicle body to selectively rotate into or out of the corresponding accommodating space.

17. The vehicle of claim 15, further comprising a plurality of the flight system is disposed on the vehicle body, and each of the wing system in the flight system is capable of sliding relative to the vehicle body to selectively slide into or out of the corresponding accommodating space.

18. The vehicle of claim 15, wherein the material of the wing should be light, firm and rigid. Such as composite materials, alloy materials, carbon fiber, etc., but not limited to these materials.

19. The vehicle of claim 15, wherein the wing is retractable and foldable, and the shape of the wing is not limited, and can be of different shapes under the premise of conforming to the principle of aerodynamics.

20. The vehicle of claim 15, wherein the flight system may be disposed at different positions on the vehicle body, such as the bottom of the vehicle, the top of the vehicle, the rear of the vehicle, but not limited to these positions.
